(19) United States
(12) Patent Application Publication
(10) Pub. No.: US 2005/0137977 A1
(43) Pub. Date: Jun. 23, 2005

(54) Method and system for biometrically enabling a proximity payment device

(76) Inventor: John Wankmueller, Great Neck, NY (US)

Correspondence Address: BAKER & BOTTS, 30 ROCKEFELLER PLAZA, NEW YORK, NY, 10112, US

(21) Appl. No.: 10/950,796

(22) Filed: Sep. 27, 2004

Related U.S. Application Data
(60) Provisional application No. 60/506,533, filed on Sep. 26, 2003.

(51) Int. Cl. G06F 17/60; G06F 1/00

(52) U.S. Cl. 705/40; 902/41

(57) ABSTRACT

A self-validating payment device for making proximity payment transactions through a point-of-sale device is provided. The payment device includes electronics for wireless communication of stored or processed payer information to the point-of-sale device. A biometric reader is integrated into the payment device. A biometric measurement of a user of the payment device in the field is compared internally with a reference biometric measurement corresponding to the user to whom the payment device is registered. The payment device self-validates itself for use according to the results of comparison.

### CROSS-REFERENCE TO RELATED APPLICATION

This application claims the benefit of United States provisional patent application No. 60/506,533, filed on Sep. 26, 2003.

### BACKGROUND OF THE INVENTION

This invention relates to methods and systems for verifying the identity of purchasers who use payment cards or other payment devices for making payments in commercial transactions. The invention in particular relates to biometric verification of the identity of a payer involved in a so-called “proximity payment” transaction.

Proximity payments are used in situations where, although the purchaser is present, it is useful or at least more convenient to be able to make a payment without having to make physical contact with the vendor/payee. The purchaser, for example, may use a contactless “smart card” to make a proximity payment without having to manually swipe a card through a conventional point-of-sale device (i.e., a magnetic strip card reader). An exemplary contactless smart card is MasterCard PayPass™ card. This card is an enhanced payment card that features a hidden embedded microprocessor chip and antennae (i.e. a miniature Radio Frequency (RF) transceiver chip and an antenna, or an active Radio Frequency Identification (RFID) tag). The MasterCard PayPass provides a purchaser with a simpler way to pay. The purchaser can simply tap or wave his or her MasterCard PayPass payment card on a specially equipped merchant terminal that then transmits payment details wirelessly using radio frequency signals, eliminating the need to swipe the card through a reader. Account details are communicated directly to the specially equipped merchant terminal and are then processed through MasterCard's highly trusted acceptance network. Moments after the purchaser taps the terminal with his or her MasterCard PayPass card, they receive payment confirmation and are on their way.

Proximity payment systems based on smartcards (such as MasterCard PayPass) may be advantageously implemented in traditional cash-only environments where speed is essential, (e.g., quick serve and casual restaurants, gas stations and movie theaters). Purchaser information, which may be stored in a microchip on the smart card, is sent directly from the microchip to a point-of-sale (POS) device or other wireless reader device, which may be up to about 10 cms away. Proximity payments also may be made using other payment devices (e.g., a mobile phone, PDA, or handheld computer), which are suitably configured to carry a microchip that stores and retransmits stored or processed account information when required. Common industry infrared or wireless protocols (e.g., Bluetooth) may govern communication between the payment device and the vendor/payee's wireless reader or POS device.

As with electronic payment transaction conducted over the Internet and other e-commerce transactions, both parties to a proximity payment transaction will have security concerns. Payers need reassurance that the vendor/payees are not unscrupulous criminals who will misuse payer information, the vendor/payees need to know that the payers are legitimate and both parties need to know that unauthorized third parties cannot intercept the transaction information. A number of techniques, which address at least some of these security concerns, are available. Data encryption techniques, for example, can be used to secure transaction information during transmission. In conventional proximity payment schemes, a remote biometric reader may be used. Over-the-air transmission of personal data to and from the biometric reader is involved. This over-the-air transmission presents an opportunity for breach or interception by unauthorized third parties.

Consideration is now directed toward improving schemes for verification of the payer's identity to prevent, for example, fraudulent use of stolen or lost payment cards. In particular, attention is directed to rapid and secure biometric verification of identity of the payers involved in proximity payment transactions.

### SUMMARY OF THE INVENTION

In accordance with the present invention, systems and methods for biometric identification of payers involved in proximity payment transactions are provided.

A self-validating payment device for making proximity payment transactions through a point-of-sale (POS) device is provided. The payment device includes conventional electronic circuits for storing and processing data, and for wireless communication with the POS device. An electronic biometric reader is physically integrated into the payment device. The biometric reader may, for example, be a fingerprint reader or a voice print reader. The biometric reader is used to acquire biometric measurements of the person who is attempting to make the proximity payment. The acquired biometric measurements are electronically processed internally or within the payment device to confirm whether the attempting person is an authorized or registered user of the payment device. For this purpose, the acquired biometric measurements may be compared with stored biometric records of the authorized or registered users. Thus, the payment device can self-validate itself for use by the attempting person according to the results of the internal comparison.

In a preferred method for conducting proximity payment transactions, individualized payment devices are issued to users. A payment device is individualized by recording usual user account information in it and by additionally recording a biometric profile or template of an authorized individual in it. In field use, the biometric reader incorporated in the payment device is used to acquire biometric measurements of a person who is attempting to use the payment device to make a proximity payment. These field biometric measurements are internally compared with the previously recorded biometric profile of the authorized individual.

Based on positive results of this comparison, the payment device may be validated for use by the person attempting to make the proximity transaction. Conversely for negative results, use of the payment device may be invalidated or disabled.

Preferably, the payment device electronic circuits are self or internally powered, for example, by provision of a dry-cell battery. Such payment devices, unlike conventional passive RFID-tag like electronic circuits, do not have to receive external RF power signals for circuit activation or functions. User identification processes can be accomplished locally in isolation at the payment device level without interaction or communication with external devices (e.g., RFID tag readers and POS devices or other wireless network access points). This isolation reduces the risk of electronic pick pocketing of account information that can occur when payment devices are continually in wireless communication with external devices.

Further features of the invention, its nature and various advantages will be more apparent from the accompanying drawings and the following detailed description.

### BRIEF DESCRIPTION OF THE DRAWING

FIGS. 1-3 illustrate the components of an exemplary assembly of a biometric reader, which is physically attached to a payment card, in accordance with the principles of the present invention.

FIG. 4 illustrates a biometric reader which is embedded in a proximity payment card, in accordance with the principles of the present invention.

### DETAILED DESCRIPTION OF THE INVENTION

The present invention is described in the context of the proximity payment transactions made using a payment card with the understanding that the inventive principles of the present invention are applicable to other types of payment instruments or devices that may be used in proximity payment transactions. Systems and methods for rapid and secure biometric identification of payers making proximity payments are disclosed.

According to the invention, a biometric reader is provided together with the payment card issued to or registered by the payer. The biometric reader is used to verify the identity of the payer by comparing a field measurement of a biometric identification parameter of choice (e.g., a fingerprint or a voice print template) with a registered identification parameter stored in the payment card. The biometric reader may according to the chosen identification parameter be a fingerprint reader or a voice print reader. The biometric reader is physically attached to the payment card in a convenient geometric arrangement.

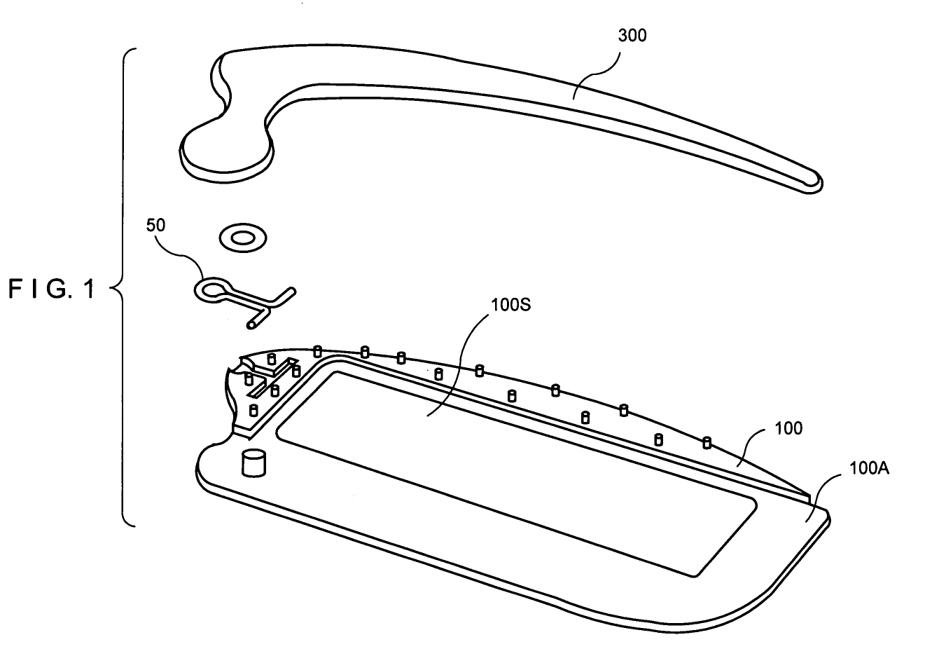

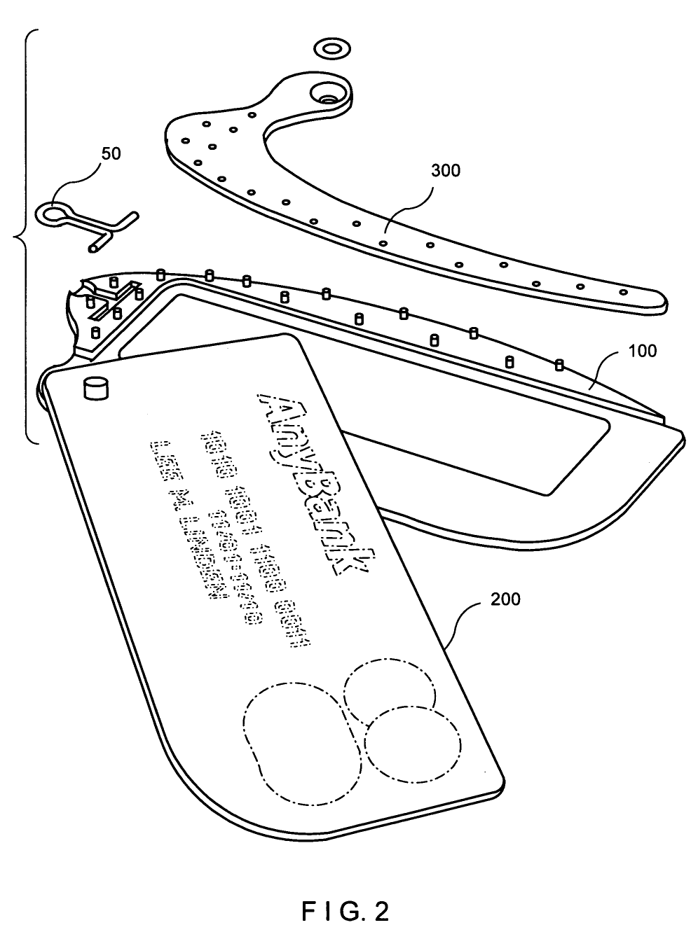

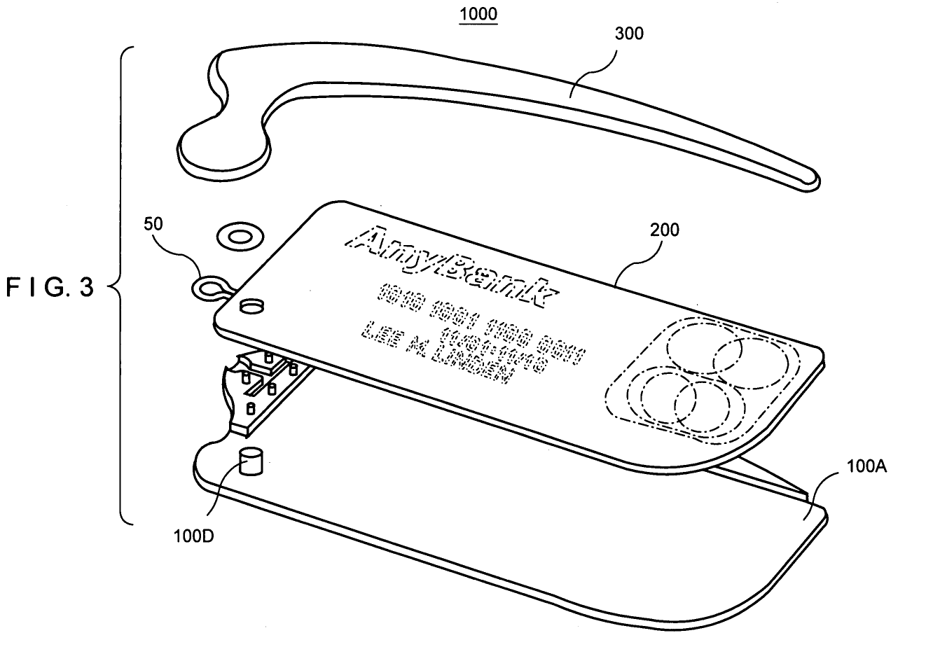

FIGS. 1-3 show the components of an exemplary geometric arrangement (e.g., common housing 1000) in which a biometric reader is physically attached to a payment card 200. Payment card 200 (e.g., a MasterCard PayPass card) may have a usual electronic arrangement of a microprocessor or RFID chip and antenna for communicating payer account information to a POS device (not shown).

In housing 1000, a biometric reader is embedded in a plastic base or cover 100A. The biometric reader may, for example, be an electronic fingerprint measurement device 100, which relies on surface capacitance measurements to record fingerprints. Fingerprint measurement device 100 may be embedded in a plastic base or cover 100A with a measuring surface 100S. Fingerprint reader 100 also may include suitable measurement/processing electronics (e.g., a microprocessor or ASIC chip) and electronics for wireless communications (e.g., a RF transceiver), which also are disposed in base 100A. The electronics may be powered by a dry cell battery embedded in base 100A (not shown). Alternatively, the electronics may be powered inductively by suitable radio frequency signals generated by a POS device, for example, in the same manner as commonly used passive RFID tags are powered by RFID tag readers. A finger guide or template 300, which guides the payer's finger to a suitable measurement position on surface 100S, is attached to plastic sleeve 100A. Finger guide 300 may be disposed at a suitable height on base 100A to so as to form a sleeve in which payment card 200 can be freely accommodated. Housing 1000 may further include an eyelet 50 or other mechanical feature for payer convenience, for example, in carrying the payment card/sleeve arrangement on a key ring or chain.

In housing 1000, payment card 200 is physically attached to the sleeve using conventional mechanical arrangements (e.g., pin or dowel 100D) so that it (card) can freely rotate or slide in and out of the sleeve. When payment card 200 is rotated out of the sleeve, measuring surface 100S is exposed and available for fingerprint measurements. The close physically proximity of payment card 200 and fingerprint reader 100 is advantageous for RF-coupling of the electronic circuits in the two components. The RF-coupling of the electronic circuits can be exploited for direct data transmission between the two components by suitable design of the electronic circuits and secure communication protocols.

In some designs of housing 1000, the electronic circuits in payment card 200 may be electrically connected to the electronics in fingerprint reader 100 by conductive wires or elements that pass through the physical attachment point (e.g., by use of a conductive pin or dowel 100d). In such designs of housing 1000, the payment card chip has a dual interface—a contact (wired) interface for the fingerprint reader functions and a contactless interface for the proximity payment functions. Suitable data communication protocols may be implemented for communication between the two interfaces to ensure data security.

Further, in such designs, some or all of the processing electronics (e.g., the microprocessor or RFID chip, used in conventional payment cards) may be advantageously moved from payment card 200 and placed in base 100a where it can be integrated with the electronics for fingerprint reader 100. Thus, a single microprocessor or chip in base 100a may be used to support the functions of both a proximity payment card and a fingerprint reader. Again secure communication protocols may be implemented for data communication between the fingerprint reader function interface and the proximity payment function interface.

In one version of housing 1000, payment card 200 is fabricated to hold only a proximity antenna for RF communications with a POS device. All of the other electronics need to support proximity payment functions and fingerprint reader functions are disposed in base 100A. Further, this arrangement can provide flexibility in the geometrical design of housing 1000 as the dimensions of base 100A (e.g., length width or thickness) are not constrained in the same manner as the dimensions of payment cards, which are subject to industry standards (See e.g., International Standards Organization (ISO) standards for the dimensions of payment cards).

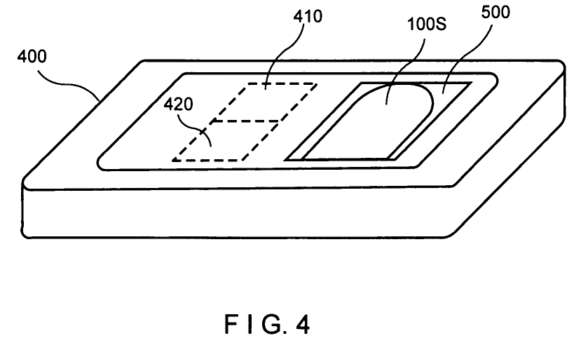

In another exemplary geometric arrangement, the biometric reader (e.g., fingerprint reader 100 or a voice print reader) may be immovably built into a payment device (e.g. a key fob). In such geometric arrangements the fingerprint reader electronics 410 and payment card electronics 420 may be advantageously integrated or hardwired together and share a common power supply. FIG. 4 shows, for example, a payment card 400, which has a built in finger print reader 500. An advantage of this geometric arrangement is the establishment of a direct physical link to communicate between the biometric reader and the proximity chip. The biometric reader deployed in this configuration is not limited in physical size to the standardized dimensions of conventional payment cards used in the banking industry (e.g., the dimensions of International Standards Organization (ISO) compliant payment cards such as those issued by MasterCard or Visa). Payment card 400 may be fabricated from plastic sheet materials in the same manner as conventional proximity payment cards (e.g., MasterCard PayPass card). The thickness of the plastic sheet materials used to fabricate payment card 400 may be suitably designed to fully embed available fingerprint reader electronics. A designated portion of either the front or back surface of the card may be configured to serve as the fingerprint measurement surface.

With renewed reference to FIG. 1, fingerprint reader 100 may be configured to extract a fingerprint template using any one of the several well-established methods of fingerprint analysis known in the art. Fingerprint reader 100 may be further configured to establish a secure communication channel to payment card 200 (i.e., to the microprocessor or RFID chip in the payment card) using any suitable data encryption algorithm to encode transmitted data. The data encryption algorithm deployed may, for example, be the symmetric triple Data Encryption Standard (DES) algorithm, which is widely used for data encryption by the government and in the banking industry. Fingerprint reader 100 may be configured to encrypt the extracted fingerprint template before transmitting it over the secured secure communication channel to card 200. Correspondingly, the microprocessor or RFID chip in payment card 200 may be configured to decrypt the received fingerprint template and to compare the decrypted fingerprint with a reference fingerprint template stored in its memory. The reference fingerprint template may be a fingerprint template, which was recorded when an authorized payer registers the payment card 200.

In a preferred method of conducting a proximity payment transaction, biometric verification of the payer's identity can be rapidly obtained using the biometric reader embedded in the proximity payment card (e.g. card 200 or 400). A payer who wishes to use, for example, payment card 200, may be required to first submit to an authentication process to verify his or her identity. For this authentication, the payer may be instructed to first slide payment card 200 out of its sleeve to expose finger print measurement surface 100S. The payer may then be instructed to place his or her index finger or thumb on fingerprint measuring surface 100S. In response, fingerprint reader 100 extracts and encrypts a fingerprint template using the deployed methods of fingerprint analysis and data encryption. Fingerprint reader 100 may next or concurrently establish a secure communication channel to payment card 200 over which the encrypted fingerplate template is transmitted to the microprocessor or RFID chip in payment card 200. Payment card 200 decrypts the received fingerprint template and electronically compares the decrypted fingerprint template with the reference template stored in its memory. According to the results of this comparison, payment card 200 may confirm that the payer is the registered payer or may determine that the payer is an unauthorized user. Payment card 200 may accordingly be self-validated or invalidated for use in the proximity transaction. In the case the payer is an unauthorized user, payment card 200 may also promptly alert, for example, store personnel, through the POS device, so that the unauthorized payer can be challenged if so desired.

The close physical proximity of the biometric reader and the payment card electronic provides a short communication link between the two which avoids over-the-air transmission of personal biometric data. Thus, the risk of interception of personal biometric data, which is present with conventional data transmissions from remote biometric readers, is reduced. Further, the intimate configuration of the biometric reader and payment card electronic circuits eliminates any need for the payee/vendee's POS device to provide any feature or function to support payer (i.e. registered cardholder) authentication.

Further, payment card/biometric card reader combinations which are self-powered (e.g., utilizing an embedded dry cell battery) may advantageously deploy passive RFID tag-like electronic circuits in the payment card component. These passive RFID tag-like circuits unlike conventional passive RFID tag circuits do not require the POS device to generate RFID beacon signals to inductively supply power to the payment card for circuit operations or activation. Thus, the payment cards may be in a normally or “always off” radio status and turned on only when the payer is validated by the localized authentication process. The “always-off ” radio status of the payment card reduces potential of electronic pick pocketing of payment account data that exists in conventional proximity payment schemes in which proximity payment RFID chips are electronically coupled to all RFID reader or POS devices in range.

Although the present invention has been described in connection with specific exemplary embodiments, it should be understood that various changes, substitutions, and alterations apparent to those skilled in the art can be made to the disclosed embodiments in accordance with the principles of the invention. For example, the principles of the invention may be applied to physically attach any two different components, which could be of different shapes and sizes, to create a physical communication channel between the two items. The physical communication channel may be used to support an authentication process in a proximity RFID chip disposed in one of the components. Using the invention, a wide variety of biometric reader types and methodologies (e.g., fingerprint or voice print templates) may be deployed in a proximity payment scheme using diverse installations of POS devices and card readers. Since the payer authentication processes are localized to payment device/biometric reader combination, imposition of a common or global biometric reader standard on the diverse installations of POS devices and card readers is not necessary.

1. A method for verifying payer identity to validate use of a payment card in a proximity payment transaction attempted through a point-of-sale device, the method comprising:
providing an electronically coupled biometric-reader in combination with the payment card to a registered payer for proximity payment use in the field, wherein the combination is physically disposed in a common housing, and wherein the combination comprises a reference biometric parameter corresponding to the registered payer;
using the biometric reader in the field to measure the payer's biometric parameter,
comparing the measured biometric parameter to the reference biometric parameter corresponding to the registered payer, and then for positive comparison validating use of the payment card for the proximity payment transaction.

2. The method of claim 2, wherein after the comparison of the measured and reference biometric parameters, for negative comparisons use of the payment card for the proximity transaction is invalidated.

3. The method of claim 2 wherein the results of the comparison are wirelessly communicated to the point-of-sale device through which the proximity payment transaction is attempted.

4. The method of claim 1 wherein the biometric reader and the payment card comprise two distinct electronic units that are in wireless communication, the method further comprising encrypting the measured biometric parameter, and then communicating the encrypted biometric parameter from the biometric reader electronic unit to the payment card electronic unit for comparison with the reference biometric parameter.

5. The method of claim 1 wherein providing the biometric reader comprises providing a fingerprint reader.

6. The method of claim 1 wherein providing a biometric reader comprises providing a voice print reader.

7. The method of claim 1 wherein providing an electronically coupled biometric-reader in combination with the payment card comprises providing a dry-cell battery to self power the combination.

8. The method of claim 7 wherein the payment card comprises a radio frequency transceiver for wireless communication with point-of-sale device for the proximity payment transaction, and wherein a default state of the radio frequency transceiver is an off state.

9. The method of claim 8 wherein the radio frequency transceiver is turned on only after the payment card is validated for use in the proximity payment transaction.

10. The method of claim 8 wherein the radio frequency transceiver is turned on after the payment card is invalidated for use to communicate the negative comparison result to point-of-sale device.

11. A payment device for making a proximity payment transaction through a point-of-sale device, the payment device comprising:
a payment card having electronics for wirelessly communicating payer information to the point-of-sale device; and
a biometric reader having electronics for measuring a biometric parameter of a user of the payment device and for communications with the payment card electronics, wherein the payment card and the biometric reader are co-disposed in a common housing.

12. The payment device of claim 11 wherein the biometric reader is physically attached to the payment card, and wherein the payment card electronics and the biometric reader electronics are distinct electronic units that are in wireless or wired communication with each other.

13. The payment device of claim 11 wherein the biometric reader electronics is embedded in the payment card.

14. The payment device of claim 13 wherein the payment card electronics and the biometric reader electronics are hardwired together.

15. The payment device of claim 11 wherein the biometric reader is a fingerprint reader.

16. The payment device of claim 11 wherein the biometric reader is a voice print reader.

17. The payment device of claim 11 wherein the payment device further comprises a reference biometric parameter corresponding to a payer to whom the payment device is registered.

18. The payment device of claim 17 wherein the payment card and biometric reader electronics are configured to compare a measured biometric parameter to the reference biometric parameter and to accordingly self-validate or invalidate the payment device for use.

19. The payment device of claim 17 wherein the payment card electronics are configured to communicate the results of the comparison to the point-of-sale device.

20. The payment device of claim 1, wherein the payment device is self-powered, and wherein the payment device has a default state in which wireless communications with the point-of-sale device are turned off.

21. The payment device of claim 20 wherein the payment device electronics are configured to resume wireless communications with the point-of-sale device only after the payment device is self-validated for use.
